(19) United States
(12) Patent Application Publication
(10) Pub. No.: US 2007/0044725 A1
(43) Pub. Date: Mar. 1, 2007

(54) Automated pet excrement extractor

(76) Inventor: Kevin Howard, Santa Rosa Beach, FL (US)

Correspondence Address: Kevin Howard, 138 Plantation Way, Santa Rosa Beach, FL, 32459, US

(21) Appl. No.: 11/510,378

(22) Filed: Aug. 25, 2006

Related U.S. Application Data
(60) Provisional application No. 60/710,822, filed on Aug. 25, 2005.

(51) Int. Cl. A01K 29/00

(52) U.S. Cl. 119/166

(57) ABSTRACT

A pet excrement encapsulation and disposal device which accepts a biodegradable cardboard capture box hinged on one of the long sides to allow the box to open and close and is snapped into the carriage assembly of the device. The carriage assembly is a skeleton with pins at each of the four feet which are set in grooves in the side walls of the apparatus. The apparatus is placed over the excrement and as the operator plunges down on the handle, the carriage assembly is forced open as the pins in the feet follow grooves designed to open the capture box to its' widest position and then snaps shut around the excrement at the bottom of the movement. The apparatus is simply picked up to complete the encapsulation. The capture box can then be discharged over a trash receptacle by activating a squeeze grip under the pump handle.

### DRAWINGS

The following drawings provide a basic description of the Extractor:

FIG. 5.1 Cradle (2)

FIG. 5.2 End (2)

FIG. 5.3 Handle (2)

FIG. 5.4 Assembly

### PRIOR ART

There are a variety of products out on the market today to accomplish the task of picking up canine excrement. None of these provide a means to retrieve excrement without some kind of handling of the pouch containing the excrement or the excrement coming into contact with the device which makes it unsanitary to use. Those that do make claims of a simple “flick of the wrist” or other type to discharge the bag with the contents are not accurately describing the method due to lack of testing of the design. Most of these devices require some form of human interface at some time. The Extractor with its' two step pump handle movement and squeeze grip discharge is a unique and simple method that does not currently exist in the patent records or on the market.

### SPECIFICATION

### DESCRIPTION OF THE INVENTION

### Background of the Invention

The retrieval of pet excrement has been an inner city problem for many years. Although manual means of retrieval have been available for some time, with more stringent regulations in rural communities, a sanitary means is essential to distance the pet owner from handling the excrement. The task of retrieval can be gruesome and nauseating, but it must be done to keep our neighborhoods clean. The products that are currently on the market do not provide an easy way to pick up the excrement while reducing human interface. There exists a need for a product that is sanitary, simple, and allows minimal human interface as well as requiring only one hand to make ready and use. The Automated Pet Excrement Extractor is such a device which the following description will disclose.

### SUMMARY OF THE INVENTION

This device is used to capture and encapsulate canine excrement by:

1. Charging the cradle assembly with a biodegradable capture box.

2. Placing the extractor over the excrement to be picked up.

3. Pushing down on the pump action handle through the full extent of its' movement.

4. Allowing the handle to return to its' original position by picking the device up.

The device may then be place over trash receptacle and with the activation of a squeeze grip, allow the encapsulation device, now known as the capture box, to fall and be easily disposed, without human contact with the capture box that contains the excrement.

The mechanism will accept one capture box at a time for one discharge with a capacity that will accommodate the discharge of most pets. The capture box is made of durable cardboard that is seamed on one edge allowing the box to open and close along this seamed “hinge.” The best configuration of the capture box is rectangular and is hinged on one of the long sides. The interior of the capture box may be treated with an adhesive substance which will help to maintain shut as well as provide a substance to break down the excrement more readily. The non-collapsible, capture box is top loaded into the cradle assembly so there is no need to mess around underneath the Extractor where feces may have contaminated the edge from a previous retrieval.

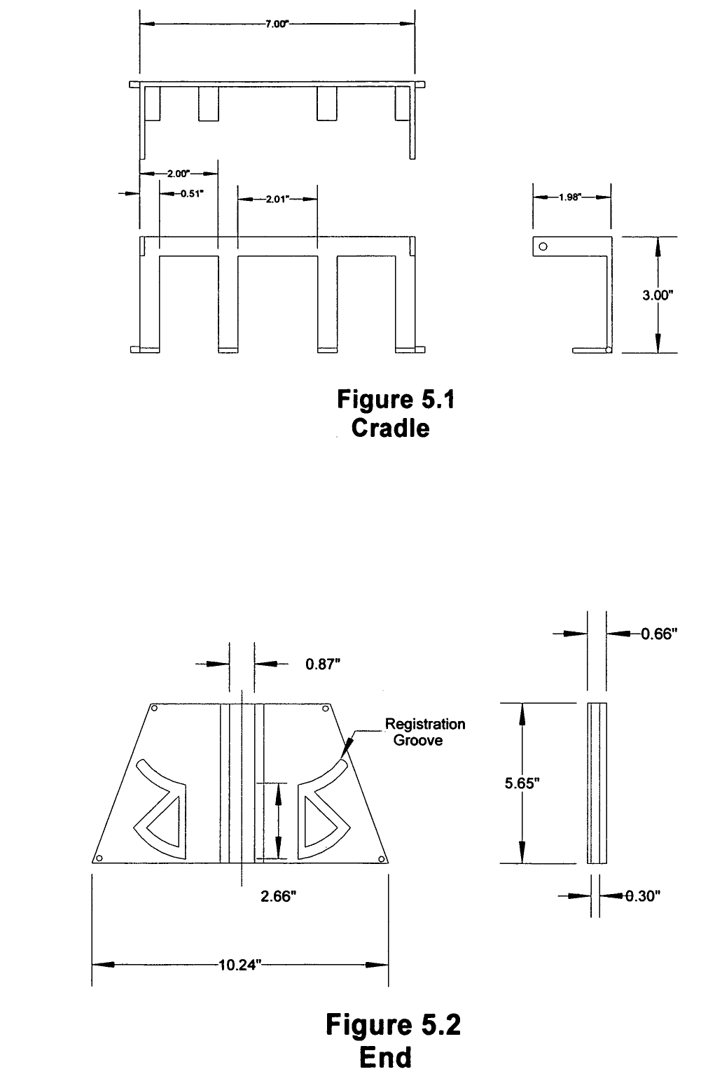

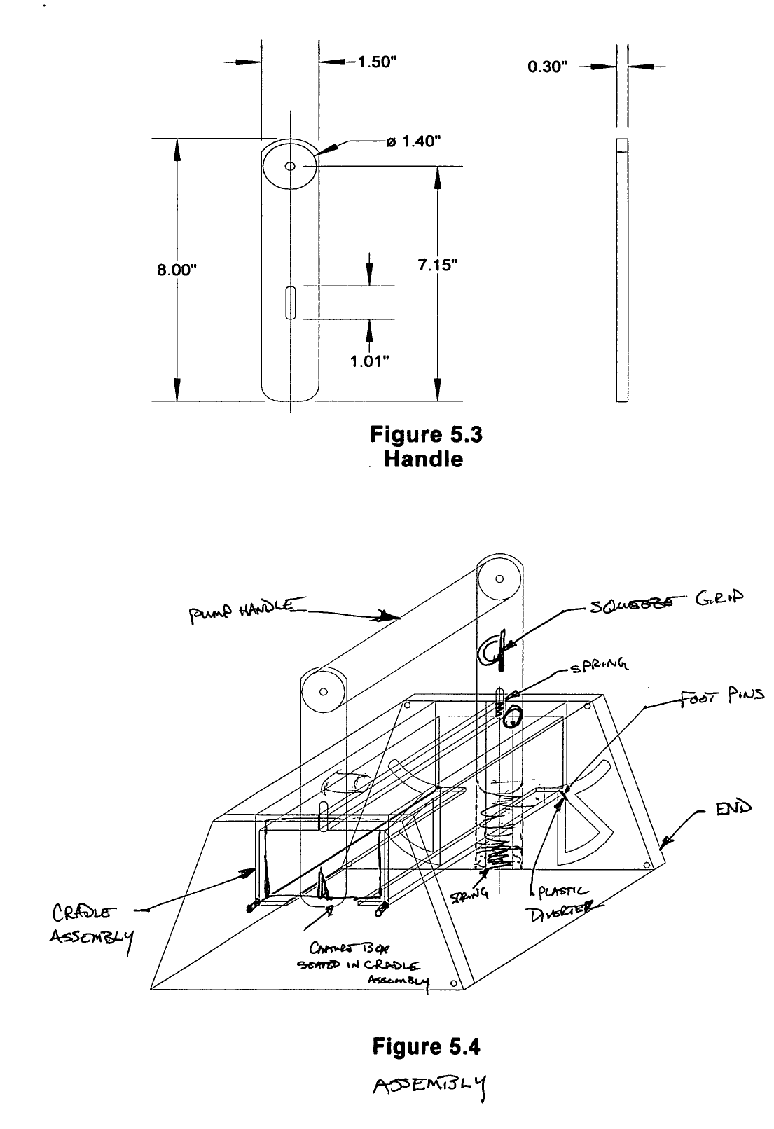

The cradle (FIG. 5.1) is a simple plastic 2-piece (duplicate of the same component) mechanism to secure the capture box, which maximizes the amount of movement around the excrement being retrieved, while providing support, ease of installation, and ease of extraction. The capture box is press fit into the cradle and becomes the cradle/capture box assembly. The cradle assembly is fixed to the handle assembly and is maintained shut under spring tension at the joint. The assembly sits in the parked position because it rests on a plastic diverter which allows the pins in the feet of the assembly to only move in the upward direction when returning to the parked position. The pump handle is set into a light spring to provide a cushioning and dampening effect on the plunging movement. As the pump handle is pushed downward, the cradle/capture box assembly is forced open by four fixed pins in each of the feet of the cradle assembly following along grooves in both end pieces of the extractor (FIG. 5.2). As the pins move away from the centerline of the box, the jaws of the cradle/capture box assembly are forced apart opening the capture box. At the end-point of the registration groove, the cradle/capture box assembly is slammed shut under the spring tension, closing the capture box around the excrement being retrieved. As the device is picked up, the pins then follow a direct upward groove passing through the plastic diverters to return the cradle/capture box assembly to the original, parked position. Once in the parked position, the capture box can be evacuated from the extractor by using the squeeze grip.

The squeeze grip is located under the handle (FIG. 5.3 and 5.4) and activates a cam-loaded spring, which opens the cradle assembly jaws in the parked position. When the squeeze grip is activated, the foot pins of the cradle assembly are allowed to open by following a different registration groove than defined above. The capture box is prevented from opening by two adjacent dowels in the opposite sides of the Extractor. The capture box slips out of the cradle assembly with its contents in tact, and out of the bottom opening of the device. Once the process is complete, the cradle assembly snaps back into the parked position and is ready to accept another capture box.

This Extractor is outfitted with a cardboard skirt which can be used multiple encapsulations. The skirt can be removed and discarded with any capture box discharge. A new skirt can then be fitted to the bottom edge of the device. This assists in making the Extractor sanitary and easy to use. The Extractor provides a simple and effective method of picking up and disposing of canine excrement without direct human contact.

What is claimed is:

1) Priority of provisional patent No. 60/710,822.

2) A pet waste encapsulation device which uses a simple two step movement by a single hand operator to capture and encapsulate pet excrement by plunging down on the pump action handle in the direction of the excrement through the extent of its movement and then picking up the device which then closes the capture box around the excrement.

3) The device of claim 2 which accepts a biodegradable capture box snapped into the cradle assembly of the device forming one complete assembly which makes the encapsulation device and makes ready the device to be used.

4) The device of claim 2, where the cradle/capture box assembly sits in the parked position waiting for activation from the pump handle and is under spring tension holding the entire assembly tightly shut and the pins at the four feet are not allowed to go down into the return grooves because a plastic diverter is covering the groove which is fixed at the bottom and allows passage from one direction when it is returned to the parked position.

5) The device of claim 2, wherein upon activating the pump handle by pushing it downward in the direction of the excrement to be encapsulated, the cradle/capture box assembly is forced open because the pins at each foot follow registration grooves in the side walls of the device and at the bottom of the movement is allowed to snap shut under spring tension and complete the encapsulation.

6) The device of claim 2, wherein the device can be applied multiple times to pick up multiple pieces or until the capture box has reached its' capacity.

7) The device of claim 2, wherein the device is returned to the parked position by simply picking up the device and the pins follow the return grooves and pass through the plastic diverter in the upward direction making ready for another encapsulation or evacuation of the capture box.

8) A pet waste disposal device where the disposal of the encapsulated pet excrement is a simple one step process by activating a squeeze grip over a trash receptacle and allowing the capture box which is maintained shut by two adjacent dowels, to slip out of the cradle assembly and fall out through the bottom of the device requiring no human contact with the device other than the activation of the squeeze grip

9) The device of claim 8, wherein the activation of the squeeze grip activates a cam loaded spring which forces the cradle assembly open and the pins in the feet of the assembly follow a second set of grooves in the side ends and the capture box is maintained shut by two adjacent dowels causing the box to maintain it's position as the cradle assembly is slid out from under it and the box falls through the bottom of the device.

10) The device of claim 8, where the capture box is treated on its' interior with an adhesive substance to maintain closed when full of excrement and one that speeds the biodegradation of the contents.
